(19) United States
(12) Patent Application Publication
(10) Pub. No.: US 2022/0340830 A1
(43) Pub. Date: Oct. 27, 2022

(54) LIGNITE TRANSIENT DEHYDRATION UPGRADING AND TEMPERATURE AND PRESSURE INSTANT GENERATION DEVICE SYSTEM

(71) Applicants: CHINA UNIVERSITY OF MINING AND TECHNOLOGY, Xuzhou (CN); JIANGSU HYDROCARBON CLEAN ENERGY TECHNOLOGY RESEARCH INSTITUTE CO., LTD., XUZHOU CITY (CN)

(72) Inventors: BO ZHANG, XUZHOU (CN); YUEMIN ZHAO, XUZHOU (CN); CHENLONG DUAN, XUZHOU (CN); ENHUI ZHOU, XUZHOU (CN); PENGFEI ZHAO, XUZHOU (CN); ZHENXING ZHANG, XUZHOU (CN); FAN YANG, XUZHOU (CN)

(21) Appl. No.: 17/729,435

(22) Filed: Apr. 26, 2022

(30) Foreign Application Priority Data
Apr. 27, 2021 (CN) 202110459250.1

(51) Int. Cl. C10L 5/04; B01J 19/00

(52) U.S. Cl. CPC C10L 5/04; B01J 19/0013; C10L 2290/08; C10L 2290/547

(57) ABSTRACT

The present disclosure relates to a lignite transient dehydration upgrading and temperature and pressure instant generation device system. Materials are added by a feeding device above the steam dehydration system and enter a feeding area, at the moment, a sealing valve is opened, an internal material platform is pushed forwards in a rotary mode, wet materials enter a dehydration area, and then the sealing valve is closed after dry materials enter. Saturated steam is added into the device by the steam generation system, then the device is adjusted to be in a high-temperature and high-pressure state by the electric control system, and the pressure is continuously stabilized for a certain period of time. The sealing valve is then opened, the dry materials enter a discharging area and then are discharged by a conveying belt, while new wet materials enter the dehydration area accordingly to begin the next round of dehydration.

### CROSS REFERENCE TO RELATED APPLICATION

This patent application claims the benefit and priority of Chinese Patent Application No. 202110459250.1, filed on Apr. 27, 2021, the disclosure of which is incorporated by reference herein in its entirety as part of the present application.

### TECHNICAL FIELD

The present disclosure belongs to the technical field of mineral processing, and in particular relates to a lignite transient dehydration upgrading and temperature and pressure instant generation device system, which is suitable for dehydration upgrading of lignite and high-water-content low-quality coal.

### BACKGROUND ART

High water content of lignite is a major factor limiting its further processing and subsequent utilization. High water content of lignite may increase transportation cost of lignite; and if the lignite is directly used to burn for power generation, the evaporation of inside water thereof needs to consume a large amount of latent heat of gasification, which reduces the efficiency of the power plant and is relatively high in CO2 emission. At present, the traditional dehydration mode for lignite and high-water-content low-quality coal in China has the defects of poor dehydration effect, easy spontaneous combustion, and easy reabsorption. To prevent the lignite and high-water-content low-quality coal from spontaneous combustion and reabsorption during dehydration, improving dehydration efficiency and large-scale industrial application are the key issues in the dehydration technology for lignite and high-water-content low-quality coal.

### SUMMARY

To overcome the disadvantages in the prior art, a lignite transient dehydration upgrading and temperature and pressure instant generation device system is provided, which overcomes the problem that the traditional dehydration mode for lignite and high-water-content low-quality coal is poor in effect and prone to spontaneous combustion and re-absorption, and is particularly suitable for large-scale industrial application due to structural characteristics thereof.

To achieve the objective, the technical solution adopted by the present disclosure is as follows:

A lignite transient dehydration upgrading and temperature and pressure instant generation device system is composed of a steam generation system, an electric control system, a steam dehydration system, a steam recovery system, and a tail gas purification device. Materials are added by a feeding device above the steam dehydration system and enter a feeding area, at the moment, a sealing valve is opened, an internal material platform is pushed forwards in a rotary mode, wet materials enter a dehydration area, and then the sealing valve is closed after the materials enter. Saturated steam is added into the device by the steam generation system, then the device is adjusted to be in a high-temperature and high-pressure state by the electric control system, and the pressure is continuously stabilized for a certain period of time; in the stage, the saturated stream takes away water in the materials through gas-liquid exchange, then a pressure relief valve is controlled by the electric control system to instantly release pressure to a normal-temperature and normal-pressure state, the internal steam causes steam explosion to destroy pores of lignite and high-water-content low-quality coal and then is guided into the steam recovery system through a pressure relief opening. At the moment, the sealing valve is opened, dry materials enter a discharging area and then are discharged by a conveying belt, while new wet materials enter the dehydration area to begin the next round of dehydration.

Further, steam generated by the steam generation system is the saturated steam under normal temperature and normal pressure, the temperature and pressure can be properly adjusted according to actual operation environments, and the feeding of the steam is controlled by an air inlet valve.

Further, an upper feed opening and a lower discharge opening of the steam dehydration system are both provided with high-pressure sealing devices to meet the sealing performance and safety of the equipment when the equipment operates under high-temperature and high-pressure conditions.

Further, the steam dehydration system comprises a temperature sensing device and a pressure intensity sensing device capable of monitoring temperature and pressure intensity changes inside the system in real time.

Further, the steam dehydration system is connected to the sealing valves of different areas under the unified regulation and control of the electric control system, and the sealing valves need to be closed constantly and good in sealing performance when the device is in a dehydration state.

Further, the steam dehydration system adopts a specially-made valve as the pressure relief valve, and the pressure relief valves are arranged at a plurality of points below the dehydration area to rapidly release the saturated steam inside the system under an instant state, thus reducing the pressure intensity and temperature inside the system and guaranteeing the dehydration effect.

Further, the steam recovery system has good thermal insulation, which can effectively reserve waste heat generated by the system, and the recovered steam is returned to the steam generation system to achieve recycling of the steam and to reduce the overall energy consumption.

Further, the tail gas purification device can filter out part of materials and dissolved ions brought out in the steam to guarantee the purity of the steam.

Further, in the large-scale industrial production, a plurality of steam dehydration system can be arranged in an array to share a set of steam generation system and recovery system.

Compared with the prior art, the present disclosure has the following advantages that in accordance with the lignite transient dehydration upgrading and temperature and pressure instant generation device system employed by the present disclosure, the material dehydration process is wrapped in the steam, the water in the material is taken away through gas-liquid exchange of the saturated steam, the dehydration effect is good, and the material is isolated from oxygen, thus the spontaneous combustion phenomenon of the material is avoided to a great extent. Moreover, as the pressure in the system is instantly released to a normal-temperature and normal-pressure state, a steam explosion phenomenon occurs inside the material, which destroys pore structures inside the material, makes the dehydration effect is be further improved, and reduces re-absorption phenomenon after the material is dehydrated. The overall system cost and energy consumption are reduced as the steam after pressure relief can be recycled through the recovery system. And the device has the advantages of being continuous in operation, high in treatment capacity, simple in process, capable of expanding processing capacity by employing the arrayed distribution, and suitable for large-scale industrial production. The device is stable and reliable in operation, good in dehydration effect, high in safety, low in energy consumption, large in processing capacity, and extensive in practicability.

### BRIEF DESCRIPTION OF THE DRAWINGS

FIG. 1 is a diagram of a device of an embodiment of the present disclosure.

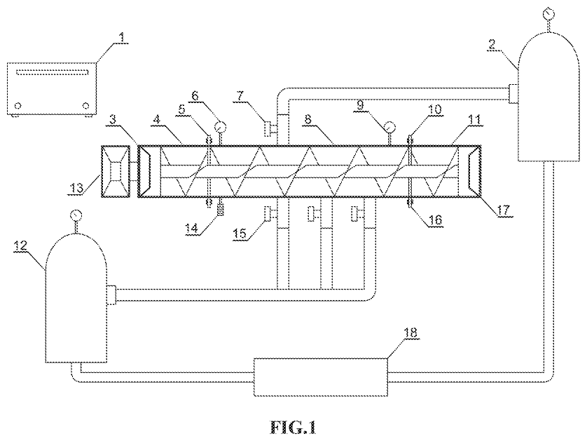

In the drawings, 1—electric control system; 2—steam generation system; 3, 17—airtight plug; 4—feeding area; 5, 6, 16—sealing valve; 6, 9—pressure intensity sensing device; 7—air inlet valve; 8—dehydration area; 11—discharging area; 12—steam recovery system; 13—feeding device; 14—temperature sensing device; 15—pressure relief valve; 18—tail gas purification device.

### DETAILED DESCRIPTION OF THE EMBODIMENTS

### Embodiment 1

A lignite transient dehydration upgrading and temperature and pressure instant generation device system is composed of a steam generation system 2, a steam dehydration system, a steam recovery system 12, and a tail gas purification device 18. Materials are added by a feeding device above the steam dehydration system and enter a feeding area 4, at the moment, sealing valves 13 and 17 are opened, an internal material platform is pushed forwards in a rotary mode, wet materials enter a dehydration area 8, and then the sealing valves 3 and 17 are closed after the materials enter. Saturated steam is added into the device by the steam generation system 2 through an air inlet valve 7, then the device is adjusted to be in a high-temperature and high-pressure state by the electric control system, and the pressure is continuously stabilized for a certain period of time; in the stage, the saturated stream takes away water in the materials through gas-liquid exchange, the pressure is instantly released to a normal-temperature and normal-pressure state by the pressure relief valve 15, the internal steam causes steam explosion to destroy pores of lignite and high-water-content low-quality coal and then is guided into the steam recovery system through a pressure relief opening. At the moment, sealing valves 5, 10 and 16 are opened, dry materials enter a discharging area 11 and then are discharged by a conveying belt, while new wet materials enter the dehydration area 8 to start the next round of dehydration.

### Embodiment 2

Lignite contains water before dehydration, the materials are added by the feeding device 13 above the steam dehydration system and then enter the feeding area 4, at the moment, the sealing valves 5 and 10 are opened, the internal material platform is pushed forwards in a rotary mode, the lignite enters the dehydration area 8, and then the sealing valves 5 and 10 are closed after the dehydrated lignite enters. The saturated steam is added into the device by the stream generation system, and then the pressure intensity is regulated to 2 Mpa by pressure intensity sensing devices 6 and 9 of an electric control system 1, and the pressure is stabilized; in the stage, the saturated stream takes away water in the lignite through gas-liquid exchange, and then a pressure relief valve 14 is controlled by the electric control system to instantly release the pressure to the normal-temperature and normal-pressure state, the internal steam causes steam explosion to destroy pores of the lignite and then is guided into the steam recovery system 12 through the pressure relief valve 15. At the moment, the sealing valves 5 and 10 are opened, the dehydrated lignite enters the discharging area 11 and then is discharged by the conveying belt, the water of the lignite is removed, and the lignite after water removal has no reabsorption phenomenon.

The above is only an individual embodiment of the present disclosure, and it should be noted that for the dehydration apparatus of the present disclosure, changes can be made to the material processing mode, the operating environment and the like without departing from the principle of the present disclosure, and these different processing modes should also be regarded as the scope of protection of the present disclosure. For those skilled in the art, several improvements and modifications can also be made without departing from the principles of the present disclosure, which should also be considered to be within the scope of protection of the present disclosure.

1. A lignite transient dehydration upgrading and temperature and pressure instant generation device system, comprising a steam generation system, an electric control system, a steam dehydration system, and a steam recovery system, wherein materials are added by a feeding device above the steam dehydration system and enter a feeding area, after a sealing valve is opened, an internal material platform is pushed forwards in a rotary mode, wet materials enter a dehydration area, and then the sealing valve is closed after the materials enter; saturated steam is added into the device by the steam generation system, then the device is adjusted to be in a high-temperature and high-pressure state by the electric control system, and the pressure is continuously stabilized for a certain period of time; in the stage, the saturated stream takes away water in the materials through gas-liquid exchange, then a pressure relief valve is controlled by the electric control system to instantly release pressure to a normal-temperature and normal-pressure state, the internal steam causes steam explosion to destroy pores of lignite and high-water-content low-quality coal and then is guided into the steam recovery system through a pressure relief opening, and at the moment, the sealing valve is opened, and dry materials enter the discharging area and then are discharged by a conveying belt.

2. The lignite transient dehydration upgrading and temperature and pressure instant generation device system of claim 1, wherein the steam generated by the steam generation system is saturated steam at normal temperature and normal pressure, and feeding of the steam is controlled by an air inlet valve.

3. The lignite transient dehydration upgrading and temperature and pressure instant generation device system of claim 1, wherein the feeding area and the discharging area are both provided with airtight plugs, and the air plugs are opened during feeding and discharging and are sealed when the device is in operation.

4. The lignite transient dehydration upgrading and temperature and pressure instant generation device system of claim 1, wherein the electric control system is used to regulate and control a heating system through the feeding and releasing of the steam, thus regulating temperature and pressure intensity inside the steam dehydration system.

5. The lignite transient dehydration upgrading and temperature and pressure instant generation device system of claim 1, wherein an upper feed opening and a lower discharge opening of the steam dehydration system are both provided with high-pressure sealing devices.

6. The lignite transient dehydration upgrading and temperature and pressure instant generation device system of claim 1, wherein the steam dehydration system comprises a temperature sensing device and a pressure intensity sensing device to monitor temperature and pressure intensity changes inside the system in real time.

7. The lignite transient dehydration upgrading and temperature and pressure instant generation device system of claim 1, wherein the steam dehydration system is connected to the sealing valves of different areas under the unified regulation and control of the electric control system, and the sealing valves are closed when the device is in a dehydration state.

8. The lignite transient dehydration upgrading and temperature and pressure instant generation device system of claim 1, wherein the pressure relief valves of the steam dehydration system are arranged at a plurality of points below the dehydration area.

9. The lignite transient dehydration upgrading and temperature and pressure instant generation device system of claim 1, wherein the steam recovery system is provided with a thermal insulating layer to make the recovered steam return to the steam generation system.

10. The lignite transient dehydration upgrading and temperature and pressure instant generation device system of claim 1, wherein the device further comprises a tail gas purification device to filter out part of materials and dissolved ions brought out in the steam.
